(19) United States
(12) Patent Application Publication
(10) Pub. No.: US 2011/0035701 A1
(43) Pub. Date: Feb. 10, 2011

(54) FOCAL POINT ZOOM

(76) Inventors: Harel M. Williams, Seattle, WA (US); Brian E. Manthos, Sammamish, WA (US); Fergal M. Burke, Redmond, WA (US); Prashant Singh, Bellevue, WA (US)

Correspondence Address: MICROSOFT CORPORATION, ONE MICROSOFT WAY, REDMOND, WA, 98052, US

(21) Appl. No.: 12/538,756

(22) Filed: Aug. 10, 2009

(51) Int. Cl. G06F 3/048

(52) U.S. Cl. 715/784; 715/788

(57) ABSTRACT

Various embodiments provide a focal point zoom component that is configured to perform a focal point zoom operation. In at least some embodiments, the focal point zoom component receives a request to perform a zoom operation at a focal point of an element in a page displayed in a display area. The focal point zoom component then performs the zoom operation on the page so that a location of the focal point relative to the element and to the display area is retained.

### BACKGROUND

Zooming in or out on a page, such as a web page, may change the layout of elements on the page. For instance, if a user zooms in on a web page displayed in a web browser, elements on the page (such as pictures or text) may change their location relative to the web browser window. A picture located at the bottom left corner of the web page in a web browser window, for example, may move to the center of the web browser window as the user zooms in on the picture. Users can easily lose their place and/or become disoriented when elements change locations relative to a display area (such as a web browser window) during zoom operations.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a focal point zoom component that is configured to perform a focal point zoom operation. In at least some embodiments, the focal point zoom component receives a request to perform a zoom operation at a focal point of an element in a page displayed in a display area. The focal point zoom component then performs the zoom operation on the page so that a location of the focal point relative to the element and to the display area is retained.

In at least some embodiments, the focal point zoom component receives a request to perform a zoom operation at a focal point of a page displayed in a display area. Responsive to receiving the request, the focal point zoom component calculates and stores information corresponding to a location of the focal point relative to the display area. The information corresponding to the location of the focal point can include a ratio of the location of the focal point relative to an element in the page in which the focal point is located. Additionally, the information corresponding to the location of the focal point can include information corresponding to a location of the element relative to the display area. The focal point zoom component then performs the zoom operation on the page. After performing the zoom operation, the focal point zoom component can scroll the page, using the information, to place the focal point of the page at a same location relative to the display area that the focal point was located prior to performing the zoom operation.

### BRIEF DESCRIPTION OF THE DRAWINGS

The same numbers are used throughout the drawings to reference like features.

FIG. 1 illustrates an operating environment in accordance with one or more embodiments.

FIG. 2 illustrates an example web browser displaying a page prior to performance of a zoom operation.

FIG. 3 illustrates an example web browser displaying a page after performance of the zoom operation in accordance with prior solutions.

FIG. 4 illustrates an example web browser displaying a page after performance of the zoom operation in accordance with one or more embodiments.

FIG. 5 is a flow diagram that describes steps in a method in accordance with one or more embodiments.

FIG. 6 illustrates an implementation example in accordance with one or more embodiments.

FIG. 7 is a block diagram of an example system that can be utilized to implement one or more embodiments.

### DETAILED DESCRIPTION

### Overview

Various embodiments provide a focal point zoom component that is configured to perform a focal point zoom operation. In at least some embodiments, the focal point zoom component receives a request to perform a zoom operation at a focal point of an element in a page displayed in a display area. The focal point zoom component then performs the zoom operation on the page so that a location of the focal point relative to the element and to the display area is retained.

In an example scenario, consider that a user may initiate a zoom operation on a picture in a web page displayed in a web browser window by positioning a mouse cursor on the picture in the web page and clicking a button on the mouse. In this instance, the location of the mouse cursor on the picture in the web page can define the focal point on which to perform the zoom operation. It is to be appreciated that the focal point is located at a specific location in the picture and at a specific location in the web browser window (e.g., the top right corner, the middle, or the bottom left corner of the web browser) at the time that the user clicks the button on the mouse.

Accordingly, the focal point zoom component can perform the zoom operation on the picture in the web page so that the focal point remains at the same location within the picture and within the web browser window. For example, if the user clicks on the center of a picture located in the bottom right corner of the web browser window, the center of the picture will be located at the same location in the bottom right corner of the web browser window after the zoom operation is performed.

In the discussion that follows, a section entitled “Operating Environment” describes but one operating environment that can be utilized to practice the inventive principles described herein in accordance with one or more embodiments. Following this, a section entitled “Focal Point Zoom Component” is provided and describes an example focal point zoom component. Next, a section entitled “Example Method” describes an example method in accordance with one or more embodiments. Next, a section entitled “Implementation Example” is provided and describes an example formula that can be used to scroll a page to place a focal point of the page at a same location in a display area at which the focal point was located prior to performing a zoom operation. Last, a section entitled “Example System” describes an example system that can be utilized to implement the described embodiments.

Operating Environment

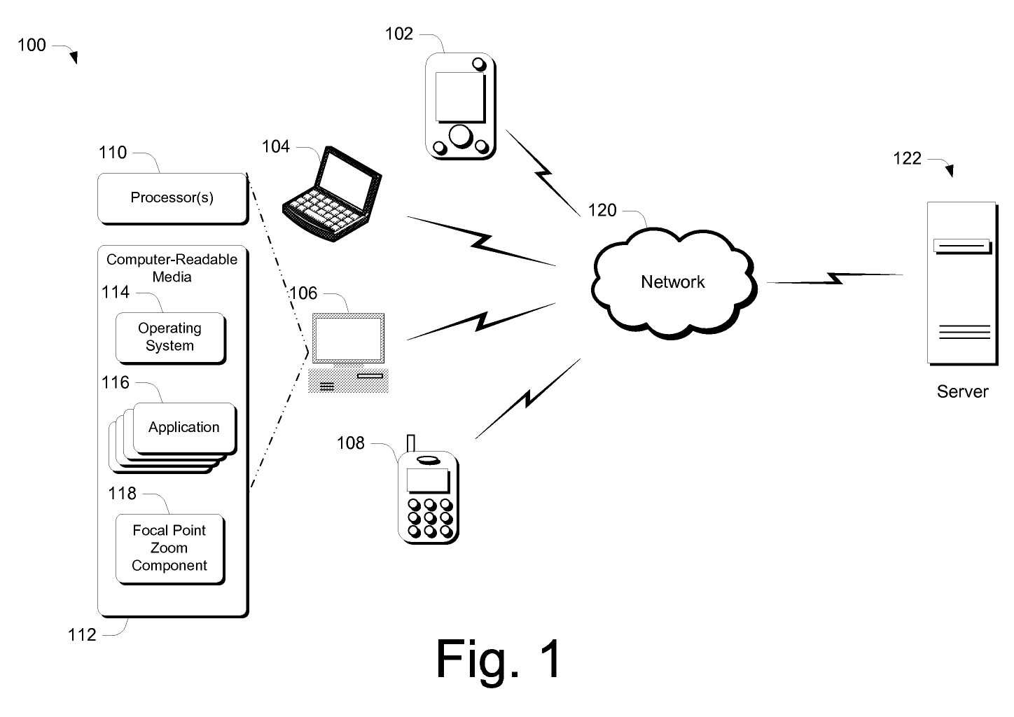

FIG. 1 illustrates an operating environment in accordance with one or more embodiments, generally at 100. Operating environment 100 includes multiple different computing devices, examples of which are shown at 102, 104, 106, and 108. The computing devices can be used to process and store pieces of information. Individual computing devices can typically include one or more processors 110, one or more computer-readable media 112, an operating system 114, one or more application(s) 116 that reside on the computer-readable media and which are executable by the processor(s), and a focal point zoom component 118. Focal point zoom component 118 can be used to perform a focal point zoom operation as described below.

The computer-readable media can include, by way of example and not limitation, all forms of volatile and non-volatile memory and/or storage media that are typically associated with a computing device. Such media can include ROM, RAM, flash memory, hard disk, removable media and the like.

In addition, in at least some embodiments, environment 100 includes a network 120, such as a local network or the Internet, via which information can be requested and sent. Operating environment 100 also includes, in at least some embodiments, a server 122. Server 122, like the individual computing devices, may be used to process and store pieces of information

The computing devices can be embodied as any suitable computing device such as, by way of example and not limitation, a desktop computer (such as computing device 106), a portable computer (such as computing device 104), a handheld computer such as a personal digital assistant (such as computing device 102), a cell phone (such as computing device 108), and the like.

Having discussed the general notion of an example operating environment in which various embodiments can operate, consider now a more detailed discussion of a focal point zoom component in accordance with one or more embodiments.

Focal Point Zoom Component

As noted above, the focal point zoom component is configured to receive a request to perform a zoom operation at a focal point of an element in a page displayed in a display area. The focal point zoom component can then perform the zoom operation on the page so that a location of the focal point relative to the element and to the display area is retained. As described throughout, a zoom operation can include zooming in (e.g. increasing the zoom percentage) and/or zooming out (e.g. decreasing the zoom percentage). In at least some embodiments, the zoom operation comprises a layout zoom operation that changes the layout of or re-lays out a page in association with each zoom operation. Re-laying out a page, therefore, may cause elements on the page to change locations relative to the display area. It is to be appreciated that a layout zoom operation is different from an optical zoom operation. Optical zoom, unlike layout zoom, linearly scales a page so that the page extends in all directions. Optical zoom, therefore, does not re-layout the page with each zoom operation.

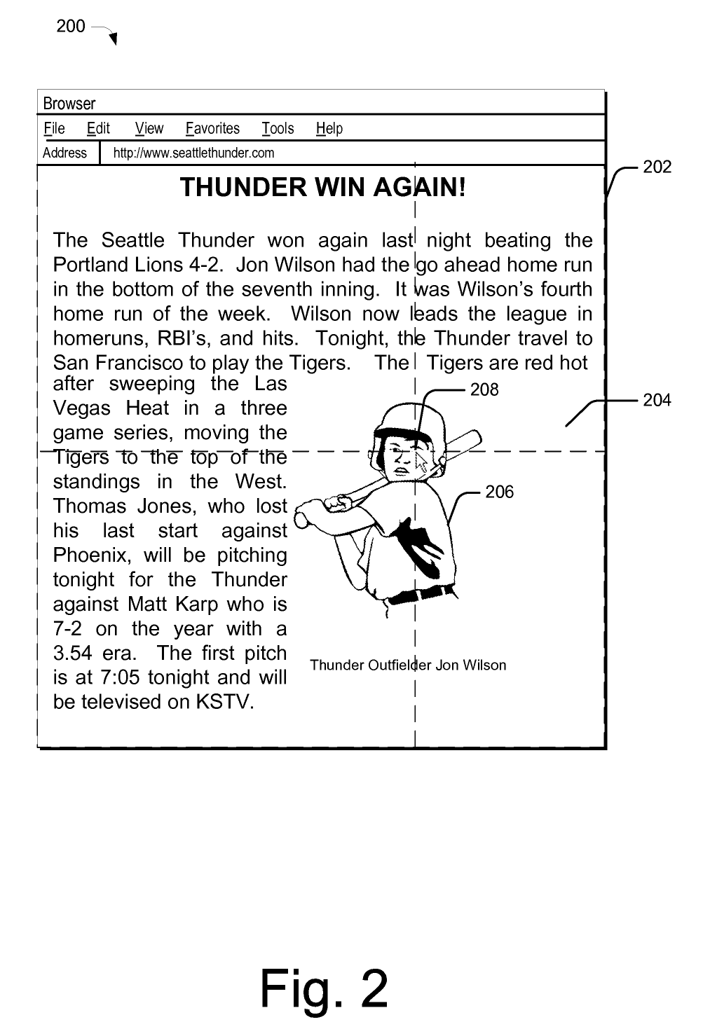

Consider for example, FIG. 2, which illustrates an example web browser user interface 200 prior to the performance of a zoom operation. Web browser user interface 200 includes a display area 202 in which a page 204 is displayed. In this instance, display area 202 is a web browser window of web browser 200. It is to be appreciated, however, that the term “display area” can be used to describe any area that is configured to display a page. In some cases, for example, the display area may comprise an entire physical display screen, such as the display screen of a mobile device. In other instances, however, the display area may be defined by other boundaries within a display screen area. For instance, a computer screen may be implemented to display one or more open windows (e.g. a web browser window such as display area 202 of FIG. 2). The display area, in this instance, may comprise the area defined by the boundary of the specific window being interacted with by a user.

Page 204, in this example, is a web page displaying a game summary of a baseball game. However, as described throughout, a “page” can include any page of content such as a web page, a digital picture, or a user interface. Page 204 includes an element 206, which in this instance is a web page picture of a baseball player. As described throughout, however, the term “element” can be used to describe any type of element in a page, such as a picture or a text box in a web page.

In FIG. 2, a user has positioned a mouse cursor at focal point 208 of element 206, which is located at the intersection of the dashed lines in FIG. 2. The dashed lines in FIG. 2 are used to show the location of focal point 208 relative to display area 202. As described throughout, the term “focal point” is used to describe the location in a page (e.g. a web page, a picture, an email message) at which a request to perform a zoom operation is received. In this example, consider that the user can zoom in or out on focal point 208 by simply clicking a button on the mouse. The location of the mouse cursor, in this case, can define the focal point (e.g. focal point 208 of FIG. 2). In at least some embodiments, a mouse wheel zoom can be initiated by a user holding the Control key while scrolling a wheel of the mouse. In this instance, scrolling the mouse-wheel in one direction can zoom in, while scrolling the mouse wheel in the opposite direction can zoom out. It is to be appreciated that there are a variety of ways in which a user can zoom in or out on a focal point.

For instance, in one or more embodiments, a request to perform a zoom operation can be received via a “touch” gesture received at a touch enabled device (e.g., via finger input on a screen of the touch enabled device). A variety of different touch gestures can be used. In accordance with at least one embodiment, a touch zoom can be initiated by a user positioning two fingers onto a screen of the touch enabled device. The focal point, in this instance, can be defined as a location halfway between positions of the two fingers on the screen. The user can move the fingers further apart to zoom the page in (e.g. zoom percentage increases). Alternately, the user can move the fingers closer together to zoom the page out (e.g. zoom percentage decreases). The zoom percentage increase or decrease, in this case, can be directly proportional to the change in distance between the locations of the fingers on the screen. In the FIG. 2 example, for instance, if the distance between the location on the screen of the fingers was doubled, the size of page 204 (including element 206) would double (e.g., increase from a 100% to a 200% zoom).

In at least some other embodiments, a request to perform a zoom operation can be received via a keyboard device. In at least one embodiment, a selection of the Control key in combination with either the plus or minus key can zoom in or zoom out, respectively. In this instance, the focal point can be defined as the center of the display area. In at least one other embodiment, a request to perform a zoom operation can be received via a user interface that includes user selectable zoom controls. In this instance, the focal point may again be defined as the center of the display area. While specific examples of requests to perform zoom operations have been discussed above, it is to be appreciated that there are a variety of different ways in which zoom operations can be requested using a variety of different mouse, touch, keyboard, and/or user interface selections and movements.

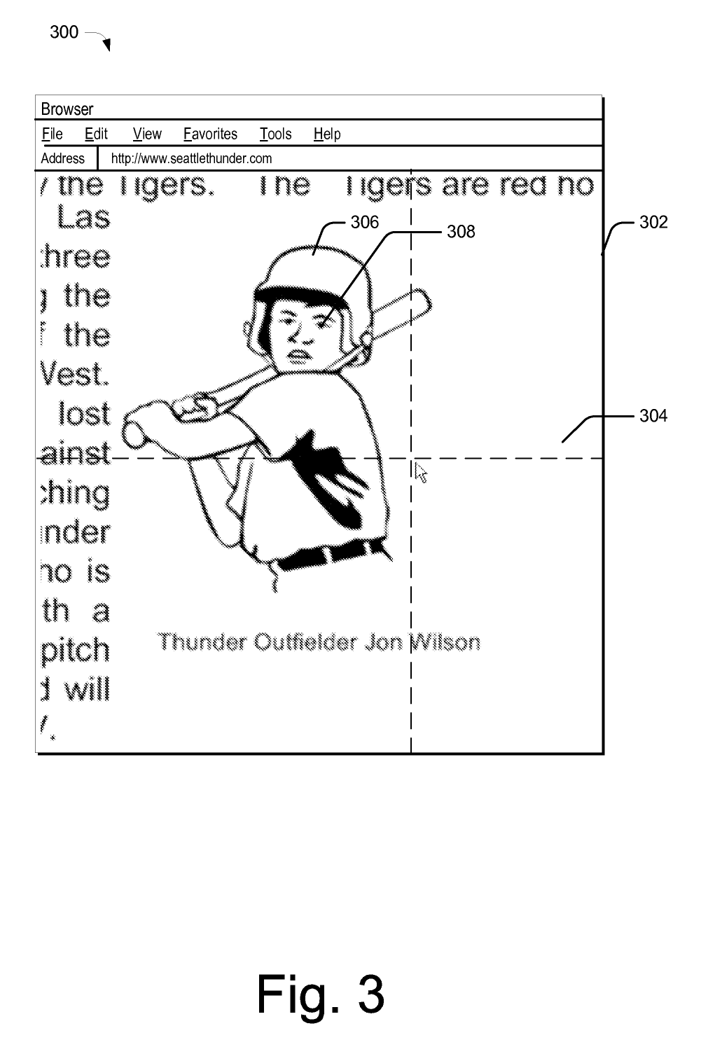

In the past, performing a zoom operation on an element caused the page and the element to be linearly scaled which would change the layout of the page. Consider, for example, FIG. 3 which illustrates an example web browser user interface 300, in accordance with previous solutions, after a user has initiated a zoom operation by clicking a mouse button at focal point 208 in FIG. 2. Notice that the size of page 304 and element 306 has increased in response to the zoom operation. Notice also that the location of page 304 and element 306 has changed relative to display area 302 so that element 306 is now located at the center of the display area and that focal point 308 is no longer positioned at the same location relative to display area 302. More specifically, in FIG. 3, focal point 308 is no longer positioned at the location of the mouse cursor at the intersection of the dashed lines as it was in FIG. 2 before the zoom operation was performed.

Performing a layout zoom operation that changes the layout of a page so that the focal point is no longer located at the same location relative to a display area may cause a user to become disoriented. For instance, if the user desires to zoom further in on element 306 in FIG. 3, the mouse cursor must be repositioned over focal point 308 from its current location at the intersection of the dashed lines.

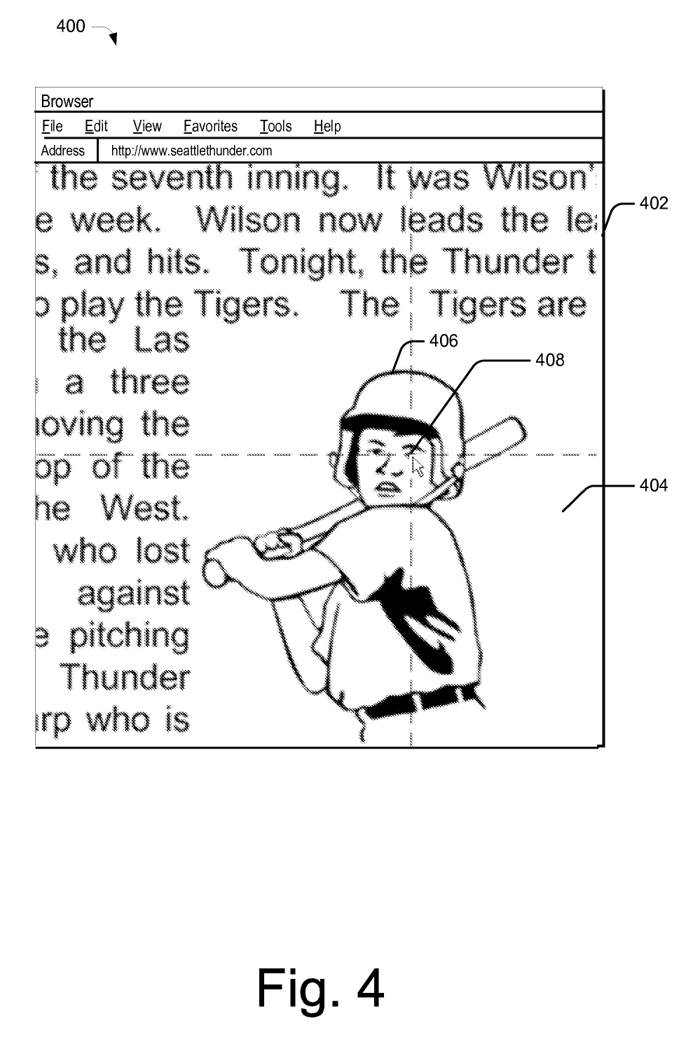

Therefore, in accordance with various embodiments, the focal point zoom component is configured to perform a zoom operation on the page so that a location of the focal point relative to the element and to the display area is retained. Consider, for example, FIG. 4 which illustrates an example web browser user interface 400, in accordance with various embodiments, after a user has initiated a zoom operation at focal point 208 in FIG. 2. Notice that similar to FIG. 3, the size of page 404 and element 406 has increased in response to the zoom operation. In FIG. 4, however, the location of focal point 408 relative to element 406 and relative to display area 402 has been retained. More specifically, focal point 408 is still located over the eye of the baseball player and at the location of the mouse cursor. It is to be appreciated that retaining the same location of the focal point relative to the element and to the display area provides the user with a more consistent and intuitive zooming experience.

In at least some embodiments, after performing a layout zoom operation on a page, the focal point zoom component can re-position the page to place the focal point of the page at a same location relative to the display area that the focal point was located prior to performing the zoom operation. For example, as discussed in more detail below, the focal point zoom component can be configured to scroll the page to place the focal point of the page at the same location relative to the display area that the focal point was located prior to performing the zoom operation. It is to be appreciated, however, that there are multiple ways in which the focal point zoom component can re-position a page after performing a zoom operation to retain a focal point of the page.

Having considered an example focal point zoom component, consider now an example method that the focal point zoom component can implement to perform a zoom operation at a focal point of an element and retain a location of the focal point relative to the element and to a display area, in accordance with one or more embodiments.

### Example Method

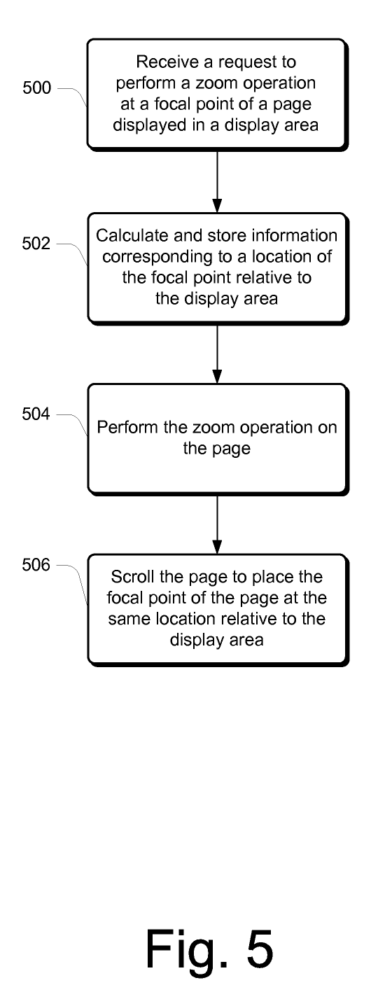

FIG. 5 is a flow diagram that describes steps in a method in accordance with one or more embodiments. The method can be implemented in connection with any suitable hardware, software, firmware, or combination thereof. In at least some embodiments, aspects of the method can be performed by a focal point zoom component, such as focal point zoom component 118, executing on a computing device or on a server, such as the computing devices and server illustrated in FIG. 1.

Step 500 receives a request to perform a zoom operation at a focal point of a page displayed in a display area. For example, in the FIG. 2 illustration, focal point zoom component 118 may be configured to receive a zoom request at focal point 208 of element 206 of page 204 displayed in display area 202. It is to be appreciated that there are a variety of different ways in which zoom operations can be requested using a variety of different mouse, touch, keyboard, and/or user interface movements and selections.

Step 502 calculates and stores information corresponding to a location of the focal point relative to the display area. In at least some embodiments, the information corresponding to the location of the focal point includes a ratio of the focal point location relative to an element in the page in which the focal point is located. In FIG. 2, for example, a ratio of the height and the width of focal point 208 relative to the height and width of element 206 can be calculated and stored. The information corresponding to the location of the focal point can also include information corresponding to the location of the element relative to the display area. For example, in FIG. 2 the location of element 206 relative to display area 202 can be calculated and stored. It is to be appreciated, however, that there are a variety of ways to calculate the location of a focal point relative to the display area.

Step 504 performs the zoom operation on the page. For example, focal point zoom component 118 may be configured to increase or decrease a zoom percentage of a page, such as page 204 in FIG. 2. In at least some embodiments, the zoom operation comprises a layout zoom. Performing a layout zoom operation on a page may cause the layout of the page to change and may move the focal point to a different location in the display area. Therefore, in accordance with various embodiments, step 506 scrolls the page, using the information corresponding to the location of the focal point, to place the focal point of the page at the same location relative to the display area that the focal point was located prior to performing the zoom operation.

In at least some embodiments, the focal point zoom component scrolls the page using the ratio of the focal point location relative to the element on the page and the information corresponding to the location of the element relative to the display area. In FIG. 4, for example, the location of page 404 has been scrolled or adjusted so that focal point 408 is at the same location relative to element 406 and relative to display area 402 at which the focal point was located prior to performing the zoom operation. In at least some embodiments, page 404 can be zoomed and then quickly scrolled or adjusted to give the appearance that the page is being smoothly zoomed in or out over the focal point. For example, the element can be smoothly zoomed in or out over the focal point while additional elements on the page are re-layed out. It is to be appreciated, therefore, that the scrolling is not meaningfully noticeable to a user. Instead, it may appear to the user as though the page is being smoothly zoomed in or out over the focal point.

In at least some embodiments, the focal point zoom component can receive an additional request to perform a zoom operation. Prior to performing the additional zoom operation, the focal point zoom component examines the stored information corresponding to the location of the focal point to determine if the information has changed. For example, if the mouse cursor has been moved or if the page has been scrolled (e.g. up, down, left, or right) by the user, it may indicate that the user no longer cares about the original focal point. Responsive to determining that the information has changed, the focal point zoom component recalculates the stored information corresponding to the location of the focal point and conducts the zoom operation.

Having discussed an example method of a focal point zoom component, consider now an implementation example.

### Implementation Example

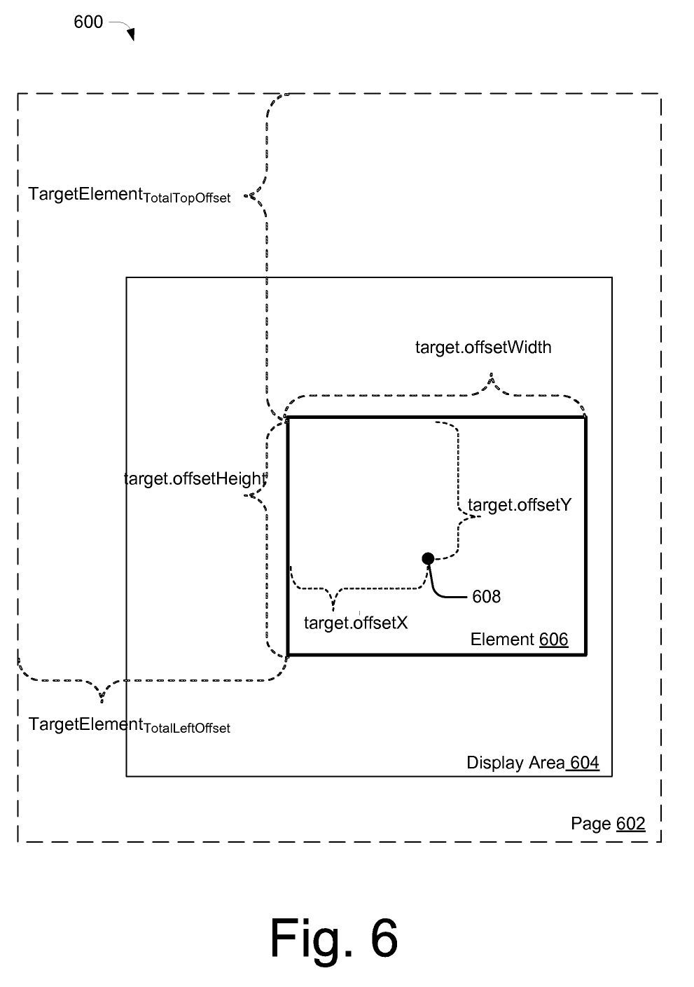

FIG. 6 illustrates an implementation example 600 in accordance with various embodiments. Example 600 includes a page 602 (e.g., a web page such as page 204), a display area 604 (e.g. a web browser window such as display area 202), an element 606 (e.g. a picture such as element 206), and a focal point 608. Notice that in this example, only a portion of page 602 is displayed in display area 604. FIG. 6 also illustrates information corresponding to a location of focal point 608 relative to element 606 and relative to display area 604 that can be calculated and stored prior to performing a zoom operation, including: target.offsetWidth, target.offsetHeight, target.offsetX, target.offsetY, targetElement_{TotalLeftOffset}, and targetElement_{TotalTopoffset}.

Target.offsetWidth and target.offsetHeight comprise the respective width and height (e.g. in pixels) of element 606. Target.offsetX comprises the horizontal distance from the left border of element 606 to focal point 608. Similarly, target.offsetY comprises the vertical distance from the top border of element 606 to focal point 608. TargetElement_{TotalLeftOffset} and TargetElement_{TotalTopoffset} comprise the respective horizontal distance from the left border of page 602 to the left border of element 606 and vertical distance from the top border of page 602 to the top border of element 606.

In at least some embodiments, and prior to performing a zoom operation, a ratio of the location of focal point 608 relative to element 606 can be calculated and stored. In at least one embodiment, the following formula is used to calculate a ratio of the horizontal location (offsetXRatio) and vertical location (offsetYRatio) of focal point 608 relative to element 606:

$$offsetXRatio = \frac{target \cdot offsetX}{target \cdot offsetWidth}$$

$$offsetYRatio = \frac{target \cdot offsetY}{target \cdot offsetHeight}$$

In the formula above, offsetXRatio is calculated by dividing the horizontal distance from the left border of element 606 to focal point 608 by the total width of element 606. Similarly, offsetYRatio is calculated by dividing the vertical distance from the top border of element 606 to focal point 608 by the total height of element 606. Calculating a ratio of the height and width of focal point 608 relative to element 606 enables the focal point zoom component to determine a location of the focal point relative to element 606. It is to be appreciated that offsetXRatio and offsetYRatio can be used to determine a location of the focal point after the element has increased or decreased in size responsive to the performance of a zoom operation. More specifically, offsetXRatio and offsetYRatio can be multiplied by the respective width and height of element 606 after a zoom operation is performed to provide the location of focal point 608 relative to element 606 after the zoom operation.

Consider, for example, that an element is 10 pixels wide by 10 pixels high. Consider also that a focal point is located 6 pixels horizontally from the left border of the element, and 8 pixels vertically from the top of the element. In this case, offsetXRatio would be calculated to be 0.6, and offsetYRatio would be calculated to be 0.8. Now, suppose that a 200% zoom operation is performed on the element that increases the size of the element to 20 pixels wide by 20 pixels high. The new location of the focal point can now be determined by multiplying offsetXRatio by the width of the element after the zoom operation (e.g., 0.6*20=12) and by multiplying offsetYRatio by the height of the element after the zoom operation (e.g., 0.8*20=16). The new location of the focal point, therefore, is 12 pixels from the left border and 16 pixels from the top border of the element after the zoom operation is performed. Notice, therefore, that the location of the focal point relative to the element has remained the same.

After calculating and storing the values above, a zoom operation can be performed that increases or decreases the zoom percentage of page 602. As discussed above, page 602 can be scrolled after performing the zoom operation, using the information corresponding to the location of the focal point, to place the focal point of the page at the same location relative to the display area at which the focal point was located prior to performing the zoom operation. Accordingly, in at least one embodiment, the focal point zoom component determines the location of the focal point as follows:

focalX=TargetElement_{TotalLeftOffset}−window.event.clientX+(targetElement_{offsetWidthNew}*offsetXRatio)

focalY=TargetElement_{TotalTopoffset}−window.event.clientY+(targetElement_{offsetHeightNew}*offsetYRatio)

In the formulas above, focalX and focalY comprise the respective x-coordinate and y-coordinate location of the focal point after the zoom operation is performed. Window.event.clientX comprises the horizontal distance from the left border of display area 604 to the left border of page 602 after the zoom operation is performed. For example, the zoom operation may linearly scale the page so that the size of the page increases in all directions. Therefore, the size of page 602 will extend further to the left of its current location in FIG. 6 after the zoom operation is performed. Similarly, window.event.clientY comprises the vertical distance from the top of display area 604 to the top border of page 602 after the zoom operation is performed. TargetElement_{offsetWidthNew} and targetElement_{offsetHeightNew} comprise the respective width and height of element 606 after the zoom operation is performed.

It is to be appreciated, therefore, that focalX and focalY comprise the respective x-coordinate and y-coordinate location of the focal point after the zoom operation is performed. More specifically, “TargetElement_{TotalLeftOffset}−window.event.clientX” provides a horizontal scroll distance to the left border of element 606. Similarly, “TargetElement_{TotalTopOffset}−window.event.clientY” provides a vertical scroll distance to the top border of element 606. Furthermore, as noted above, calculating a ratio of the height and width of focal point 608 relative to element 606 enables the focal point zoom component to determine a location of the focal point relative to element 606 as element 606 increases or decreases in size from due to a zoom operation.

Therefore, (TargetElement_{offsetWidthNew}*offsetXRatio) provides the location of the focal point from the left border of the element after the zoom operation, and (TargetElement_{offsetHeightNew}*offsetYRatio) provides the location of the focal point from the top border of the element after the zoom operation. It is to be appreciated, therefore, that adding together the distance to the border of the element (e.g., targetElement_{TotalLeftOffset}−window.event.clientX) and the distance from the border of the element to the focal point (e.g., targetElement_{offsetWidthNew}*offsetXRatio) provides the location of the focal point. Accordingly, after performing the zoom operation, the focal point zoom component scrolls the page to a location of focalX, focalY so that the focal point is at the same location relative to the element and relative to the display area at which the focal point was located prior to performing the zoom operation.

In at least some embodiments, the focal point zoom component can receive an additional request to perform a zoom operation. Prior to performing the additional zoom operation, the focal point zoom component examines the stored information corresponding to the location of the focal point to determine if the information has changed. In this case, the information corresponding to the location of the focal point can include information corresponding to a scroll location of the element and a mouse cursor location. For example, if the page has been scrolled (e.g. up, down, left, or right) by a user or if the mouse cursor has been moved by the user, it may indicate that the user no longer cares about the original focal point. Responsive to determining that the information has changed, the focal point zoom component recalculates the stored information corresponding to the location of the focal point and can perform a zoom operation.

Responsive to determining that the information has not changed, the focal point zoom component can retain the ratio of the location of the focal point relative to the element (e.g. offsetXRatio and offsetYRatio) and adjust other stored information corresponding to the location of the focal point to account for rounding errors that may subsequently occur when performing multiple zoom operations. Alternately or additionally, the focal point zoom component can examine the ratio of the location of the focal point relative to the element to determine if the ratio has changed due to rounding errors. Responsive to determining that the ratio has changed, the focal point zoom component can recalculate the ratios as discussed above.

In at least one embodiment, and prior to performing the zoom operation, the focal point zoom component is configured to detect that a page is equipped with a zoom application. For example, some mapping web pages may have a built-in zoom application that can be used to zoom in or out on various map locations. When the focal point zoom component detects that a page has its own zoom application, the focal point zoom component enables the zoom application to perform the zoom operation by transmitting the information corresponding to the location of the focal point (e.g. focalX, focalY, offsetXRatio, offsetYRatio, target.offsetWidth, target.offsetHeight, target.offsetX, target.offsetY, targetElement_{TotalLeftOffset}, and/or targetElement_{TotalTopOffset}) to the zoom application. The zoom application can then perform the focal point zoom operation using the information.

In at least one embodiment, the focal point zoom component is configured to be compatible with existing zoom applications. In other words, existing zoom applications do not need to be modified in order to be compatible with the focal point zoom application (e.g., existing zoom applications do not need to write to an API of the focal point zoom component). The focal point zoom component is compatible with existing zoom applications because it can transmit information that existing zoom applications are already configured to receive.

Having discussed an implementation example, consider now a discussion of an example system that can be used to implement one or more embodiments.

### Example System

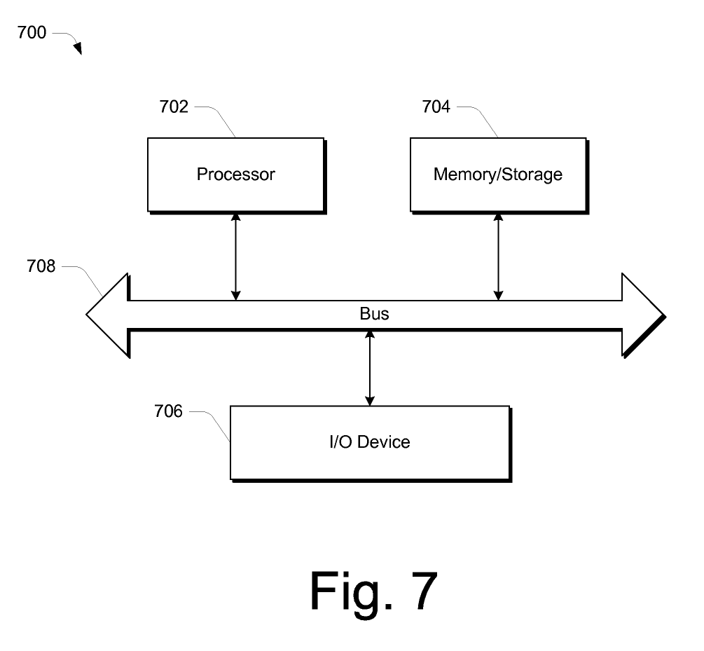

FIG. 7 illustrates an example computing device 700 that can implement the various embodiments described above. Computing device 700 can be, for example, various computing devices or servers, such as those illustrated in FIG. 1 or any other suitable computing device.

Computing device 700 includes one or more processors or processing units 702, one or more memory and/or storage components 704, one or more input/output (I/O) devices 706, and a bus 708 that allows the various components and devices to communicate with one another. Bus 708 represents one or more of any of several types of bus structures, including a memory bus or memory controller, a peripheral bus, an accelerated graphics port, and a processor or local bus using any of a variety of bus architectures. Bus 708 can include wired and/or wireless buses.

Memory/storage component 704 represents one or more computer storage media. Component 704 can include volatile media (such as random access memory (RAM)) and/or nonvolatile media (such as read only memory (ROM), Flash memory, optical disks, magnetic disks, and so forth). Component 704 can include fixed media (e.g., RAM, ROM, a fixed hard drive, etc.) as well as removable media (e.g., a Flash memory drive, a removable hard drive, an optical disk, and so forth).

One or more input/output devices 706 allow a user to enter commands and information to computing device 700, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide a focal point zoom component that is configured to perform a focal point zoom operation. In at least some embodiments, the focal point zoom component receives a request to perform a zoom operation at a focal point of an element in a page displayed in a display area. The focal point zoom component then performs the zoom operation on the page so that a location of the focal point relative to the element and to the display area is retained.

In at least some embodiments, the focal point zoom component receives a request to perform a zoom operation at a focal point of a page displayed in a display area. Responsive to receiving the request, the focal point zoom component calculates and stores information corresponding to a location of the focal point relative to the display area. The information corresponding to the location of the focal point can include a ratio of the location of the focal point relative to an element in the page in which the focal point is located. Additionally, the information corresponding to the location of the focal point can include information corresponding to a location of the element relative to the display area. The focal point zoom component then performs the zoom operation on the page. After performing the zoom operation, the focal point zoom component can scroll the page, using the information, to place the focal point of the page at a same location relative to the display area that the focal point was located prior to performing the zoom operation.

Although the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter

What is claimed is:

1. A computer-implemented method comprising:
receiving a request to perform a zoom operation at a focal point of a page displayed in a display area;
calculating and storing information corresponding to a location of the focal point relative to the display area;
performing the zoom operation on the page; and
scrolling the page, using the information, to place the focal point of the page at a same location relative to the display area that the focal point was located prior to performing the zoom operation.

2. The computer-implemented method as recited in claim 1, wherein the information corresponding to the location of the focal point includes a ratio of the location of the focal point relative to an element in the page in which the focal point is located.

3. The computer-implemented method as recited in claim 2, wherein the information corresponding to the location of the focal point includes information corresponding to a location of the element relative to the display area.

4. The computer-implemented method as recited in claim 2, wherein the ratio of the location of the focal point relative to an element in the page comprises:
a width ratio of the location of the focal point relative to a width of the element in the page; and
a height ratio of the location of the focal point relative to a height of the element in the page.

5. The computer-implemented method as recited in claim 1, wherein the zoom operation comprises a layout zoom operation.

6. The computer-implemented method as recited in claim 1, wherein the request is received via a mouse device, and wherein the focal point comprises a location of a cursor of the mouse on the page when the request is received.

7. The computer-implemented method as recited in claim 1, wherein the request is received via finger input on a screen of a touch enabled device, and wherein the focal point comprises a location halfway between positions of two fingers on the screen.

8. The computer-implemented method as recited in claim 1, further comprising:
receiving an additional request to perform a zoom operation;
examining stored information corresponding to the location of the focal point to determine if the stored information has changed; and
responsive to determining that the stored information has changed, recalculating the stored information corresponding to the location of the focal point.

9. The computer-implemented method as recited in claim 1, further comprising:
prior to performing the zoom operation, detecting that the page is equipped with a zoom application; and
enabling the zoom application to perform the zoom operation by transmitting the information corresponding to the location of the focal point to the zoom application.

10. One or more computer-readable storage media embodying computer executable instructions, which when executed by one or more processors perform a method, comprising:
receiving a request to perform a layout zoom operation at a focal point of a page displayed in a display area;
performing the layout zoom operation on the page; and
re-positioning the page to place the focal point of the page at a same location relative to the display area that the focal point was located prior to performing the layout zoom operation.

11. One or more computer-readable storage media as recited in claim 10, further comprising calculating and storing information corresponding to a location of the focal point relative to the display area prior to performing the layout zoom operation, wherein the information is used to re-position the page to place the focal point of the page at the same location relative to the display area that the focal point was located prior to performing the zoom operation.

12. One or more computer-readable storage media as recited in claim 11, further comprising:
receiving an additional request to perform a layout zoom operation;
examining stored information corresponding to the location of the focal point to determine if the stored information has changed; and
responsive to determining that the stored information has changed, recalculating the stored information corresponding to the location of the focal point.

13. One or more computer-readable storage media as recited in claim 11, wherein the information corresponding to the location of the focal point includes a ratio of the location of the focal point relative to an element in the page in which the focal point is located.

14. One or more computer-readable storage media as recited in claim 13, wherein the ratio of the location of the focal point relative to an element in the page comprises:
a width ratio of the location of the focal point relative to a width of the element in the page; and
a height ratio of the location of the focal point relative to the height of the element in the page.

15. One or more computer-readable storage media as recited in claim 13, wherein the information corresponding to the location of the focal point includes information corresponding to a location of the element relative to the display area.

16. One or more computer-readable storage media as recited in claim 10, wherein the request is received via two finger input on a screen of a touch enabled device, and wherein the focal point comprises a location halfway between positions of two fingers on the screen.

17. A computer-implemented method comprising:
receiving a request to perform a zoom operation at a focal point of an element in a page displayed in a display area;
performing the zoom operation on the page so that a location of the focal point relative to the element and to the display area is retained.

18. The computer-implemented method as recited in claim 17, wherein the zoom operation comprises a layout zoom operation.

19. The computer-implemented method as recited in claim 17, wherein the request is received via a mouse device, and wherein the location of the focal point comprises a location of a cursor of the mouse on the page when the request is received.

20. The computer-implemented method as recited in claim 17, wherein the request is received via finger input on a screen of a touch enabled device, and wherein the location of the focal point comprises a location halfway between positions of two fingers on the screen.
